(19) United States
(12) Patent Application Publication
(10) Pub. No.: US 2009/0106274 A1
(43) Pub. Date: Apr. 23, 2009

(54) SYSTEM AND METHOD FOR APPLICATION CREATION

(76) Inventor: Benjamin D. Temple, Overland Park, KS (US)

Correspondence Address: HUSCH BLACKWELL SANDERS LLP, 4801 Main Street, Suite 1000, KANSAS CITY, MO, 64112, US

(21) Appl. No.: 11/876,774

(22) Filed: Oct. 23, 2007

(51) Int. Cl. G06F 17/30

(52) U.S. Cl. 707/100; 707/E17.001

(57) ABSTRACT

There is provided according to an embodiment of the present inventive interface and method, whereby providing a user with an authoring interface for user selection of a website theme and one or more objects, placing the one or more user selected objects one or more website pages according to parameters defined in the user selected theme and as well as system provided one or more layout blocks, binding data dynamically as user adds objects to one of forms, and dynamically allocating data schema including internal relationships according to one or more form object attributes,

### CROSS-REFERENCE TO RELATED APPLICATIONS

This application claims priority to U.S. Provisional patent application No. 60/862,437 entitled “System and Method for Application Creation” filed Oct. 21, 2006.

### SUMMARY OF THE INVENTION

The foregoing needs are met, to a great extent, by the present invention, wherein in one aspect an apparatus is provided that in some embodiments A method for creating data driven applications including the steps of providing a user with an authoring interface for user selection of a website theme and one or more objects, placing the one or more user selected objects one or more website pages according to parameters defined in the user selected theme and as well as system provided one or more layout blocks, binding data dynamically as user adds objects to one of forms, and dynamically allocating data schema including internal relationships according to one or more form object attributes. Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

### BRIEF DESCRIPTION OF THE SEVERAL VIEWS OF THE DRAWING

Further features of the present invention will become apparent to those skilled in the art to which the present invention relates from reading the following description with reference to the accompanying drawings, in which:

FIGS. 1-8 are simplified illustrations of an interface presented to a user in accordance with an embodiment of the present inventive method and system.

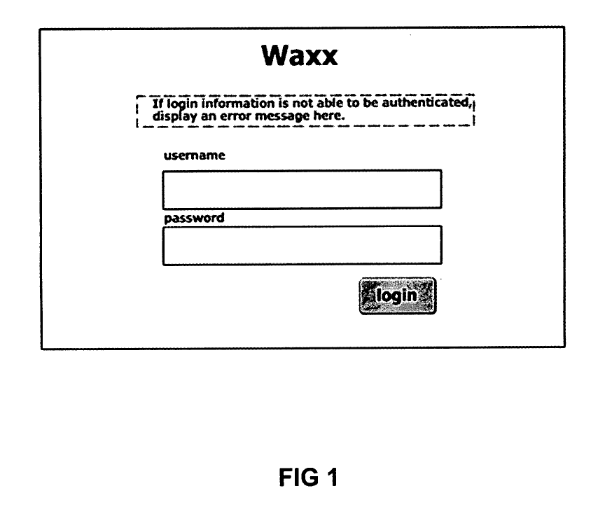

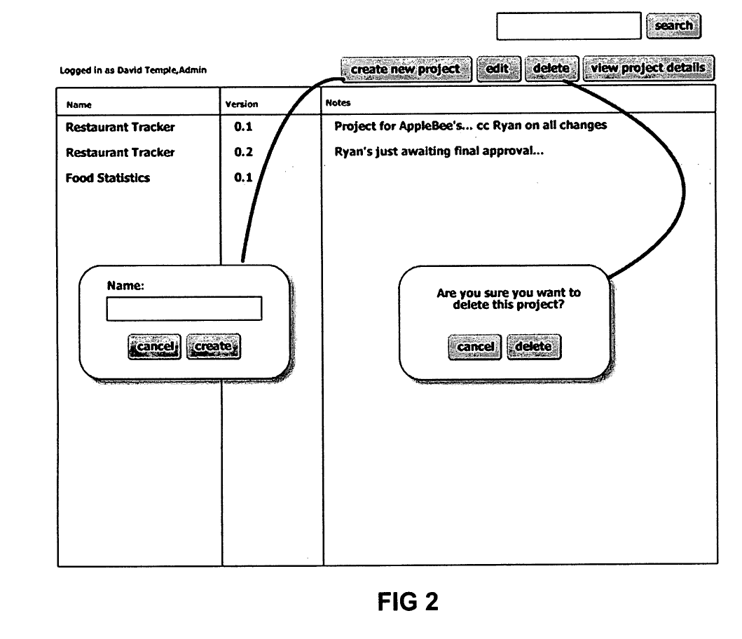

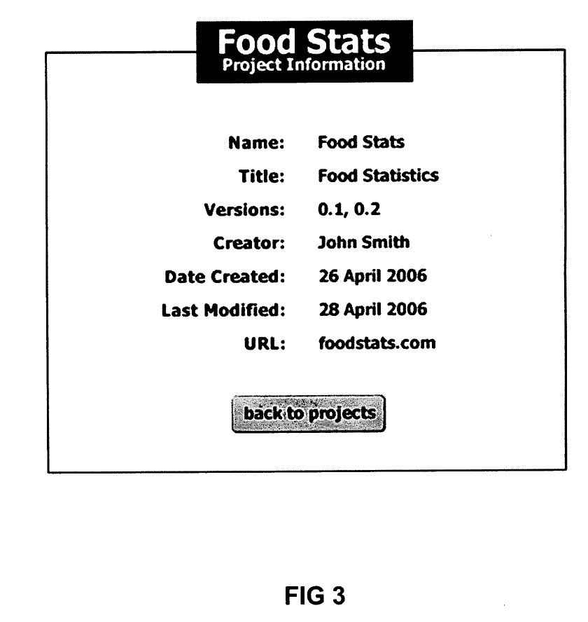

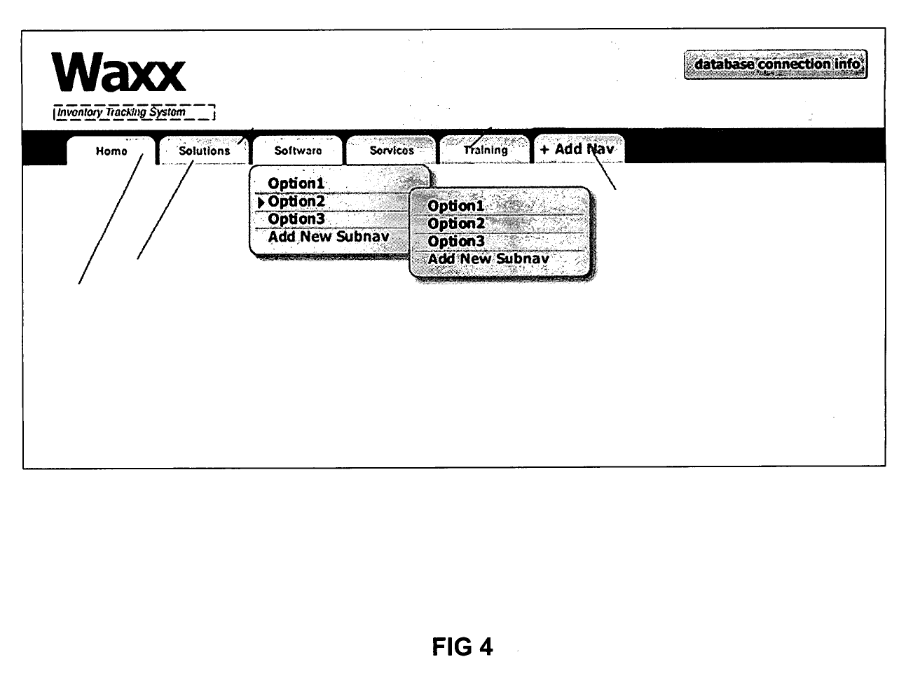

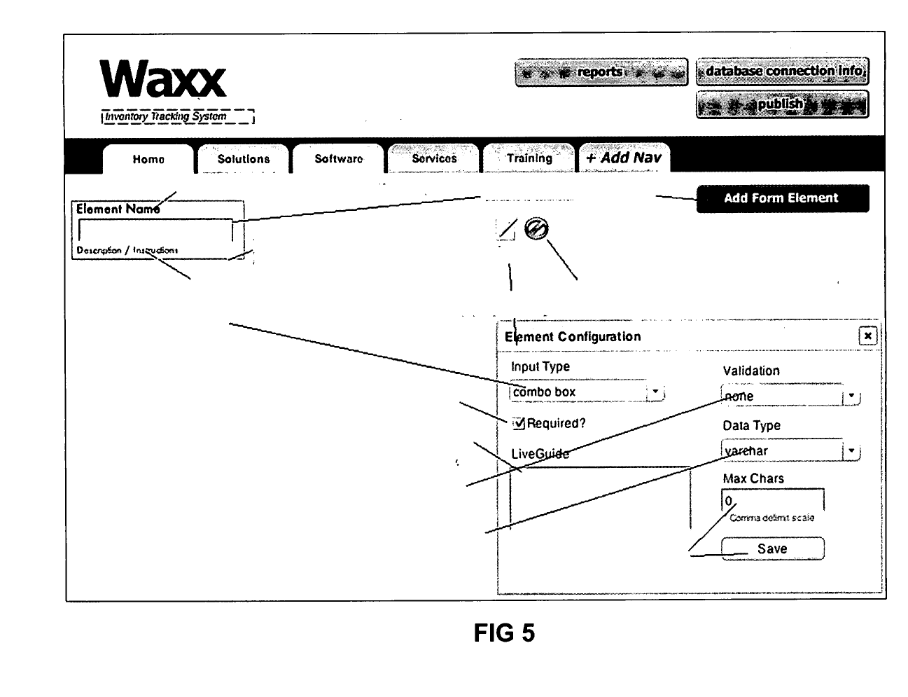

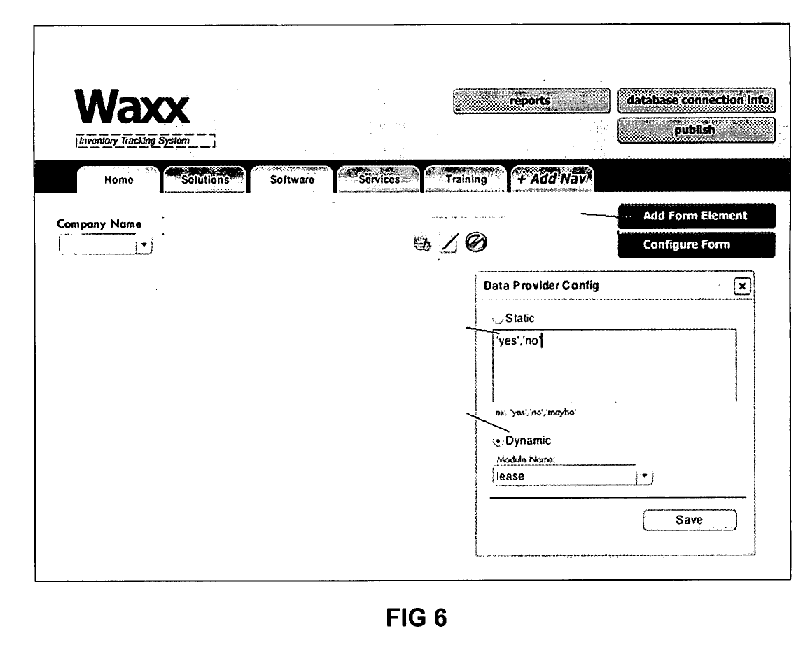

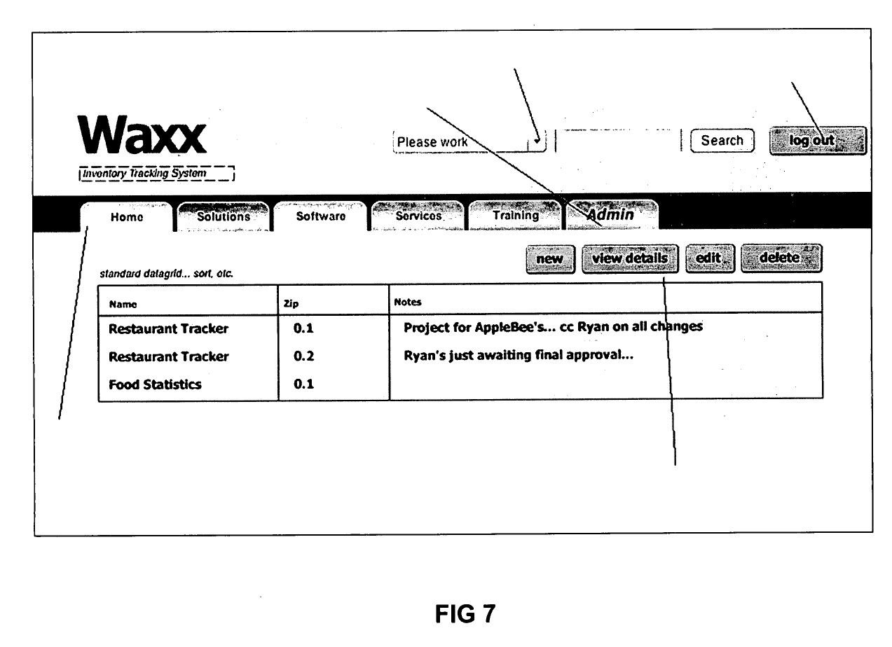

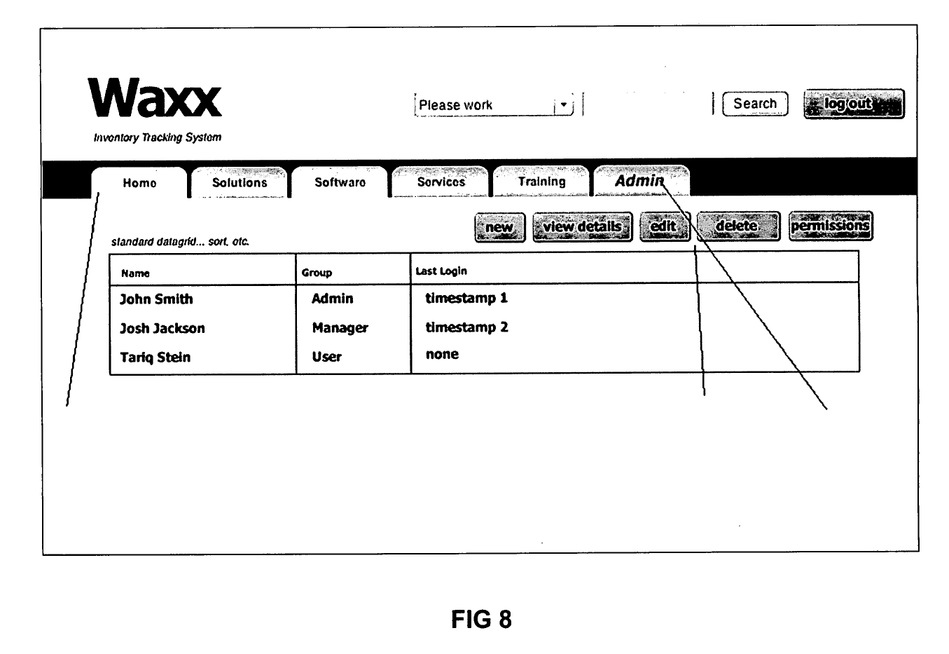

### DETAILED DESCRIPTION OF THE INVENTION

The invention will now be described with reference to the drawing figures, in which like reference numerals refer to like parts throughout. Overview: Creation of GUI and data occur simultaneously (behind the scenes) while the user creates forms with data input elements.

GUI→User creates application ui in browser using standard flash plug-in. The user may add data elements and modules to the application. A “module” may be a calendar, embedded video, photo gallery, etc. The user selects a “theme” which defines a set of presentation boundaries for the application user interface.

Layout Blocks are presented to the user using an algorithm that performs randomization of the application interface layout (within the presentation boundaries of the theme). Color schemes are randomly generated by the system are presented to the user for use in the application interface. The resulting color schemes that are presented to the user are consistent and within the presentation boundaries of the theme. Additionally, certain layout options may be bounded by parameters defined by theme.

According to one embodiment of the present invention, processing duties take place (i.e.—on client, server parses stuff and sends x to client).

Data→Determination of Data Repository Architecture and Table structures Data binding occurs automatically/dynamically based on user selection of data element types. For example:

| | |
|---|---|
| Text Box | One to one relationship |
| Drop-List Box (also radio buttons) | One to many relationship |
| Check Box | Many to many relationship |

Appropriate tables are generated auto magically in an optimized fashion.

Additionally, mapped tables are generated in the case of one to many relationships. The resulting data tables and repository architecture are lightweight, extensible and normalized.

Additionally, the values certain data input elements (drop-list box) can be populated by associating the drop down control with another data element. Waxx System takes the user input, selections, etc. . . . and cranks out/internally stores→Logic.

Abstraction—Waxx internal representation of Application. According to one embodiment of the present invention the “application” stored in raw logic form in an one or more xml file. Alternatively, the logic is stored in logic primitive format in a data repository. Logic Parsing to crank out application & database.

Flash Based User Interface—Logic translated and passed to client interface via run time parameters send via server side code. According to one embodiment of the present invention, the client interface is a flash application which contains much of the logic needed to display and gather user input. The server will send Flash an XML file with the specifics of the application, and Flash will render it. Flash and the server will be in constant communication, and certain business logic tasks will be handled by Flash, and certain tasks will be handled by the server.

It should be noted that this may be executed dynamically, meaning that Flash and the Server will “talk” and decide who should handle what depending on the specific application. Server side code handles many Create, Read, Update, Delete (CRUD) operations between client interface program and the data repository.

According to one embodiment of the present invention, components of an Application created by Waxx include: Client—runs flash GUI operations (for creation of application and use of application). Server—Server Side logic parsing and data repository for CRUD operations. Repository—Database operations and information storage.

Certain embodiments of the invention are outlined above in order that the detailed description thereof may be better understood, and in order that the present contributions to the art may be better appreciated. There are, of course, additional embodiments of the invention that will be described below and which will form the subject matter of the claims appended hereto.

In this respect, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Though some features of the invention may be claimed in dependency, each feature has merit when used independently.

One of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

We claim:

1. A method for creating data driven applications including the steps of:
(system) provides user with flash-based authoring interface where a user selects a theme and can add objects to one or more forms/screens;
placement of user added objects onto forms is handled by the system according to the user selected theme and randomly generated layout blocks;
data binding occurs dynamically as user adds objects to one of forms;
data schema (including internal relationships—one to many, etc) are dynamically created by the system according to one or more form object attributes (is the object a text box, drop list box, or check box?); and
resulting application elements into a repository as application/business logic, server-side code, and data schema.

2. The method of claim 1 further comprising the step of creating a data schema to correspond to one or more user added form objects.

3. The method of claim 3 wherein the step of creating a data schema to correspond to one or more user added form objects further comprises determining if said one or more user created form objects is a radio button, drop down box, or a text entry field.

4. A method for creating data driven applications including the steps of:
parsing through the stored application elements and uses a lookup table (containing server-side code for various functions in several different languages) and matches business logic to corresponding server-side code functions;
creating a data repository and data relationships according to stored data schema elements; and
providing a universal application client interface component for accessing said resulting data driven application; and
presenting application forms to a user via said universal application client interface by parsing run-time parameters passed to said universal application client interface.

5. The method of claim 4 where said universal application further comprising the step of communicating between a data repository and said universal application client interface via server side code.

6. The method of claim 4 where said universal application client interface component is a compiled flash program.

7. The method of claim 4 further comprising the steps of:
determining a field type based on user input (i.e. text and numeric formatting); and
dynamically creating a data field to correspond to said field type.
